(19) United States
(12) Patent Application Publication
(10) Pub. No.: US 2010/0236685 A1
(43) Pub. Date: Sep. 23, 2010

(54) Transfer Device and Transfer Method for Printed Sheets of Paper

(75) Inventor: Takahiko Nakamura, Fuchu-shi (JP)

Correspondence Address: THE WEBB LAW FIRM, P.C., 700 KOPPERS BUILDING, 436 SEVENTH AVENUE, PITTSBURGH, PA, 15219, US

(73) Assignee: RYOBI LTD., Fuchu-shi (JP)

(21) Appl. No.: 12/726,765

(22) Filed: Mar. 18, 2010

(30) Foreign Application Priority Data
Mar. 19, 2009 (JP) 2009-067871

(51) Int. Cl. B32B 37/00

(52) U.S. Cl. 156/60; 156/362

(57) ABSTRACT

An object is to provide a transfer device and a transfer method for printed sheets of paper that are capable of matching the traveling speed of a transfer film to the conveying speed of printed sheets of paper irrespective of the thickness of printed sheets of paper. The transfer device includes a transfer section for transferring patters of a transfer film onto a surface of each of printed sheets of paper conveyed by a cylinder; a traveling speed setting means for setting the traveling speed of a transfer film according to the thickness of each of the printed sheets of paper; and a speed control means for controlling the actual traveling speed of the transfer film so as to match the actual traveling speed of the transfer film to the traveling speed of the transfer film set by the traveling speed setting means.

### CROSS REFERENCE TO RELATED APPLICATION

This application claims priority from Japanese Patent Application No. 2009-067871, which is incorporated herein by reference.

### BACKGROUND OF THE INVENTION

1. Field of the Invention

The present invention relates to a technique of pressing a transfer film onto printed sheets of paper to transfer thereon gold foil, embossed patterns, hologram patterns, and the like, thereby to increase added value of the printed surfaces, and more particularly, to a transfer device and a transfer method that are designed to transfer patters of a transfer film onto a printed surface of a printed sheet of paper when in transferring.

2. Related Art

There is already proposed a gloss finishing apparatus for providing added value to printed sheets of paper in the above-mentioned manner. The apparatus includes a varnishing unit that applies an ultraviolet curable resin varnish (also simply referred to as “a varnish”) onto the printed sheets of paper printed at a printing unit and a hologram forming unit of endless type that presses a transfer film for transferring onto the printed sheets of paper varnished at the varnishing unit, so that a hologram pattern of a hologram surface of the transfer film, which is endlessly traveling, is embossed onto the surface of each successively conveyed printed sheet of paper, thereby transferring the embossed pattern on the printed sheet of paper (cf. Japanese Patent Application Laid-open No. 2006-315229).

### SUMMARY OF THE INVENTION

According to the gloss finishing apparatus of the aforesaid Japanese Patent Laid-open No. 2006-315229, the operation is made to make the film traveling speed of the transfer film match (equal) to the conveying speed of oncoming printed sheets of paper (or simply referred also to printed sheets).

Meanwhile, the conveying speed of printed sheets varies depending on the difference in thickness of the printed sheets (i.e., the thickness of each of printed sheets to be processed in one printing operation). Even in this condition, the film running speed is set without taking into account the thickness of each printed sheet in the aforesaid Japanese Patent Laid-open No. 2006-315229. For example, the actual film running speed is set at a film running speed corresponding to the conveying speed of a printed sheet having a thickness frequently used.

Therefore, when printed sheets having a thickness different from the thickness of the printed sheets, to which the conveying speed is correspondingly set, the conveying speed of printed sheets becomes different from the film traveling speed. As a result, not only the transfer film is not highly accurately matched in position to the printed sheets, but also slippage occurs between the transfer film and the printed sheets, which may cause troubles, such as adverse effects on the printing quality. Thus, there is a room for improvement.

Thus, in order to solve the above problem with taking into account the above circumstances, it is an object of the present invention to provide a transfer device and a transfer method that are capable of matching the film running speed of a transfer film to the conveying speed of printed sheets even though each of printed sheets to be processed in one operation becomes different from the thickness in another operation.

According to one aspect of the present invention, there is provided a transfer device for printed sheets of paper that includes: a transfer section for transferring patters of a transfer film onto a surface of each of printed sheets of paper conveyed by a cylinder; a traveling speed setting means for setting the traveling speed of a transfer film according to the thickness of each of the printed sheets of paper; and a speed control means for controlling the actual traveling speed of the transfer film so as to match the actual traveling speed of the transfer film to the traveling speed of the transfer film set by the traveling speed setting means.

According to another aspect of the present invention, there is provided a transfer method for printed sheets of paper that includes: transferring patters of a transfer sheet onto printed sheets of paper during conveyance of both the transfer sheet and the printed sheets of paper, wherein the traveling speed of the transfer film is matched to the conveying speed of the printed sheets of paper by adjusting the traveling speed of the transfer film according to the thickness of each of the printed sheets of paper.

With the above transfer device for printed sheets of paper, it is possible to perform the speed control for a transfer film by the speed control means so as to allow the traveling speed of the transfer film to be adjusted to an appropriate traveling speed only by setting the traveling speed of the transfer film according to the thickness of printed sheets of paper.

With the above transfer method for printed sheets of paper, it is possible to match the traveling speed of the transfer film to the conveying speed of printed sheets of paper by adjusting the traveling speed of the transfer film according to the thickness of printed sheets of paper.

According to the transfer device for printed sheets of paper, it is possible to employ an arrangement, in which the traveling speed setting means is a means for setting the traveling speed of the transfer film at a traveling speed corresponding to a certain thickness for printed sheets of paper, and the transfer device further includes a traveling speed correction means for correcting the traveling speed of the transfer film set by the traveling speed setting means in 1% unit.

Also, the transfer method for printed sheets of paper may further include setting the traveling speed of the transfer film at a traveling speed corresponding to a certain thickness for printed sheets of paper, and correcting the set traveling speed of the transfer film in 1% unit.

With the correction of the set traveling speed of the transfer film in 1% unit, even if the previously set traveling speed of the transfer film is different from the actual traveling speed, it is possible to forcibly absorb such speed difference by the correction.

Since the control can be made so as to adjust the actual traveling speed to an appropriate traveling speed only by setting the traveling speed according to the thickness of printed sheets of paper, it is possible to match the traveling speed of the transfer film to the conveying speed of printed sheets of paper. Thus, it is possible to provide a transfer device and a transfer method for printed sheets of paper that are capable of matching the traveling speed of the transfer film to the conveying speed of printed sheets of paper, irrespective of the thickness of printed sheets of paper.

### BRIEF DESCRIPTION OF THE DRAWINGS

The above, and other objects, features and advantages of the present invention will become apparent from the detailed description thereof in conjunction with the accompanying drawings wherein.

FIG. 1 is a schematic side view of a printing press;

FIG. 2 is a side view of a transfer section;

FIG. 3 is a control block diagram of the transfer section.

FIG. 4 is a flowchart showing the operation of a control unit.

FIG. 5 is a front view of a monitor screen.

### DESCRIPTION OF THE PREFERRED EMBODIMENTS

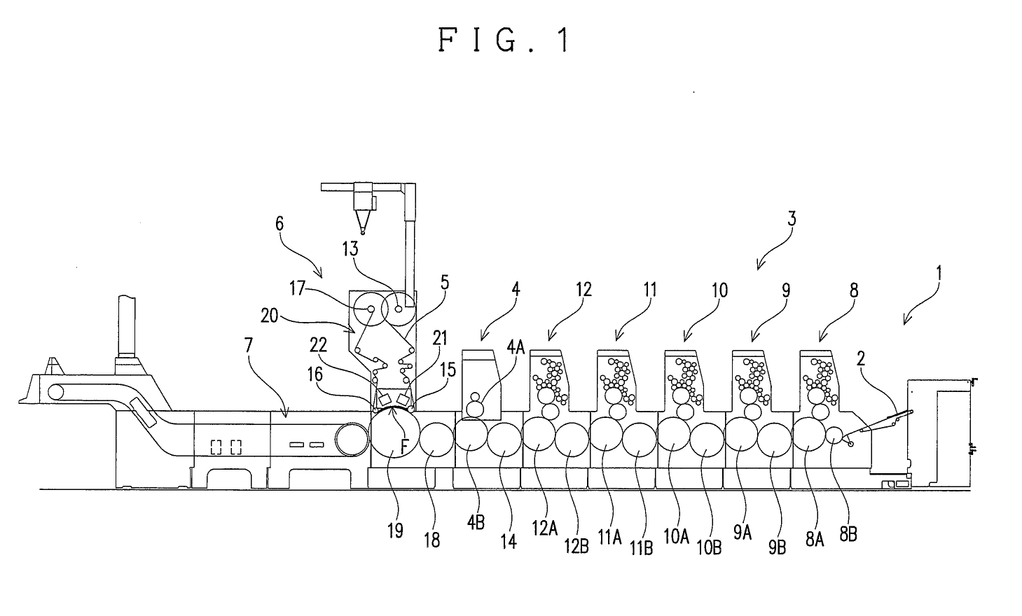

FIG. 1 shows an example of a printing press incorporating a transfer device 6 capable of treating the printed surfaces of printed sheets of paper by varnishing and gloss-finishing the printed surfaces with a resin varnish and transferring thereon gold foil, embossed patterns, hologram patterns, and the like. This printing press includes a sheet feeder section 1, a printer section 3, a varnish applicator section 4, a transfer section F, and a sheet discharge section 7. The sheet feeder section 1 feeds sheets of paper 2 one by one or one at a time by means of a feeder device, a sheet separator device, etc., from a sheet stack table. The printer section 3 performs five-color printing on the sheets 2 fed from the sheet feeder section 1. The varnish applicator section 4 applies (coats) an ultraviolet curable resin varnish (also simply referred to as “a varnish”) onto the sheets 2 that have been printed at the printer section 3. The transfer section F presses a transfer film 5 made of a stretchable material with restoring force (e.g., polyethylene terephthalate, so-called PET; other materials may also be used), onto the ultraviolet curable resin varnish over the sheets 2 that have been applied with the ultraviolet curable resin varnish at the varnish applicator section 4, thereby treating the surfaces of the sheets 2. The sheet discharge section 7 discharges the sheets 2 whose surfaces have been treated at the transfer section F. Although the printer section 3 includes five printing units 8, 9, 10, 11, and 12 so that five-color printing can be performed in the present embodiment, a printer section may be capable of printing other colors than five colors, such as a single color or more than one colors. In addition, while the sheet discharge section 7 is constructed of a chain conveyor device with grippers, the printing press may not include the sheet discharge section 7, and the specific structure of each section constituting the printing press is not limited to that shown in the figure. Also, while sheets of paper are used as printed sheets herein, a printed sheet may be a continuous elongate sheet. Further, the transfer device 6 may be built in the printing press to be used therein, whilst the transfer device 6 may not be built in the printing press to be used as a single independent unit.

In the case of attaching gold foil to the printed surfaces, a foil applicator called a foiler is used to press printed material, so that gold foil is peeled off from a substrate onto a portion with an adhesive material (or may be varnish) of the printed material attached thereto. The printed surfaces may also be applied with something other than gold foil.

The printing units 8 to 12 include, respectively, printing impression cylinders 8A to 12A as well as delivery cylinders 8B to 12B on the respective upstream sides of the printing impression cylinders 8A to 12A in a conveying direction, for delivering sheets 2 to the printing impression cylinders. Of the delivery cylinders 8B to 12B, the delivery cylinder 8B that has a small diameter and locates at the leading end in the conveying direction is also referred to as a sheet feeder cylinder, and this delivery cylinder 8B, the feeder device, sheet separator device, etc., together constitute the sheet feeder section 1. Although not shown in the figure, each of the impression cylinders 8A to 12A and the delivery cylinders 9B to 12B is provided with grippers, each having a jaw block and a gripping jaw to grip a fed sheet 2, at two positions (one gripper may be provided at a single position or more than two grippers may be provided at more than two positions) in a circumferential direction. Although not shown, the delivery cylinder 8B of a small diameter is provided with a gripper having a jaw block and a gripping jaw to grip a sheet 2, at a single position in the circumferential direction. Also, the varnish applicator section 4 includes a varnishing cylinder 4A from which the ultraviolet curable resin varnish is supplied and an impression cylinder 4B that is located opposite to the varnishing cylinder 4A to coat the ultraviolet curable resin varnish over the printed sheets 2.

A delivery cylinder 14 is provided to deliver the printed sheets 2 to the impression cylinder 4B. Although not shown, each of these cylinders 14 and 4B is also provided with grippers, each having a jaw block and a gripping jaw to grip a fed sheet 2, at two positions (one gripper may also be provided at a single position or more than two grippers may also be provided at more than two positions) in the circumferential direction, as with the above cylinders.

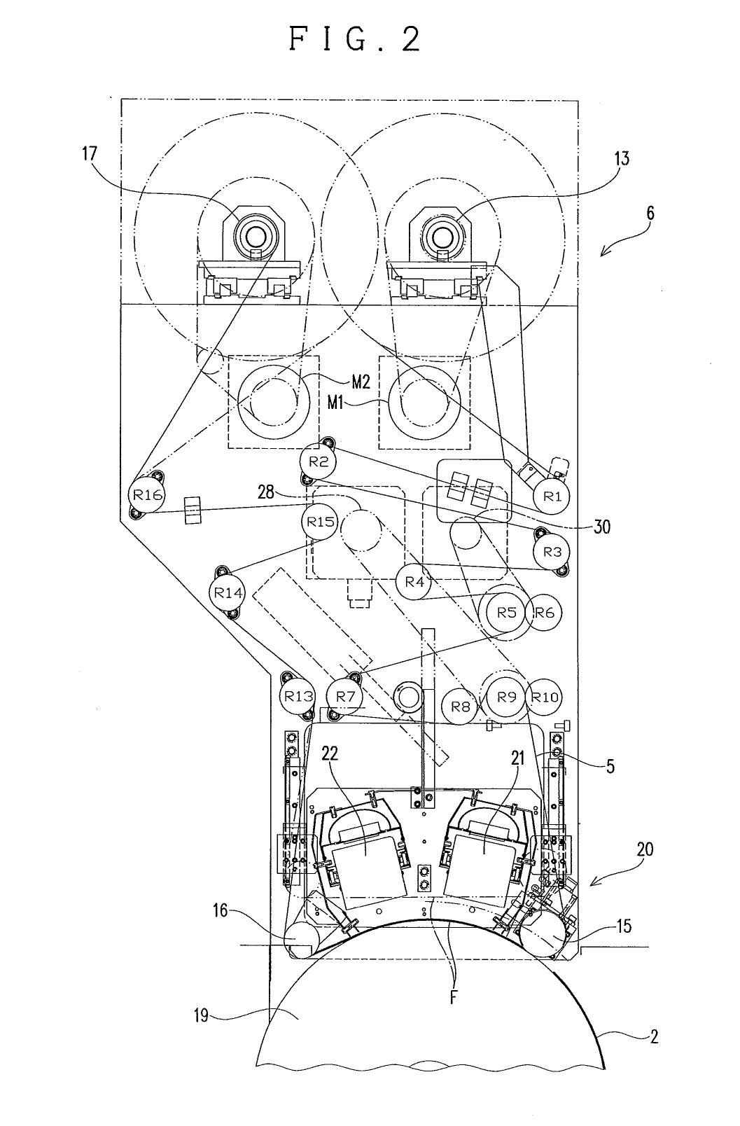

As shown in FIGS. 1 and 2, the transfer device 6 includes an impression cylinder 19 and a film transfer mechanism 20. The impression cylinder 19 receives the printed sheets 2 from a delivery cylinder 18 that is provided to receive the printed sheets 2 from the impression cylinder 4B. The film transfer mechanism 20 presses the transfer film 5 onto the printed sheets 2 on the impression cylinder 19 to perform transfer a pattern of the transfer film 5 thereon. The film transfer mechanism 20 is a mechanism that presses the transfer film 5 onto the printed sheets 2 to transfer gold foil, embossed patterns, hologram patterns, etc., from the transfer film 5 onto the printed sheets 2 while utilizing, as an adhesive agent, the ultraviolet curable resin varnish that has been applied at the varnish applicator section 4. Pressing the transfer film 5 onto the ultraviolet curable resin varnish over the printed sheets 2 enables the surfaces applied with the ultraviolet curable resin varnish to be smoothened and the surfaces to be made even glossier. Then, ultraviolet irradiating lamps 21 and 22 (one or more than two lamps may be provided) irradiate the pressed film 5 with ultraviolet rays from above to cure the ultraviolet curable resin varnish. The delivery cylinder 18 is also provided with grippers for gripping sheets 2 at two positions (one gripper may be provided at a single position or more than two grippers may be provided at more than two positions) in the circumferential direction, as with the above cylinders. The impression cylinder 19 is a so-called triple-diameter cylinder that has a larger diameter than the delivery cylinder 18 and is provided with grippers at three positions (not shown) in the circumferential direction, as with the above cylinders; therefore, the delivery cylinder 18 rotates 1.5 times while the impression cylinder 19 rotates a single time, whereby a sheet 2 can be passed to a gripper on the impression cylinder 19 from a gripper on the delivery cylinder 18 as described above. The impression cylinder 19 having a larger diameter (triple-diameter cylinder) than the other cylinders advantageously ensures a larger drying zone for the irradiation of ultraviolet rays as well as a longer distance from the varnish applicator section 4, but it is to be noted that the impression cylinder 19 may have the same diameter as the other cylinders.

In detailed description of the transfer device 6, as shown in FIGS. 1 and 2, the transfer device 6 includes a feed roll 13, two pressing rollers 15 and 16 (one or more than two may be provided), and a windup roll 17. The feed roll 13 is capable of winding up the transfer film 5 therearound and feeding out the same therefrom. The pressing rollers 15 and 16 are respectively disposed upstream and downstream in the circumferential direction of the impression cylinder 19 to press the transfer film 5 fed out from the feed roll 13 onto the printed sheets 2 on the impression cylinder 19. The windup roll 17 winds up the transfer film 5 therearound, which is peeled off from the printed sheets after being pressed by the pressing rollers 15 and 16. In FIG. 2, film guiding rollers R1 to R10 are disposed between the feed roll 13 and the upstream pressing roller 15. Film guiding rollers R13 to R16 are disposed between the downstream pressing roller 16 and the windup roll 17. The downstream pressing roller 16 is disposed at a position that is spaced upward from the impression cylinder 19 by a set distance for the reason that the film 5 can thereby be separated (peeled off) smoothly from the printed sheets 2; however, the pressing roller 16 may be disposed at a position enabling itself pressingly contact the impression cylinder 19.

The feed roll 13 is driven to rotate by the power of an electric motor M1 for the feed roll, and the windup roll 17 is driven to rotate by the power of an electric motor M2 for the windup roll. While a total of four electric motors, i.e., the two electric motors M1 and M2 and two electric motors 28 and 30 for drivingly rotating the rollers R9 and R5 for tension adjustment applied to the transfer film 5 are basically operated in synchronization with one another, the rotation speeds of the electric motors, which sometimes cause loosening or excessive tension in the transfer film 5, are controlled so as to favorably eliminate such loosening or excessive tension. Thus, the position of the transfer film 5 relative to the printed sheets 2 can be adjusted by performing this tension adjustment. In addition to the structure in which the transfer film 5 fed out from the feed roll 13 is wound up around the windup roll 17, it is possible to employ a structure in which rolls are disposed so as to be capable of endlessly conveying the transfer film 5

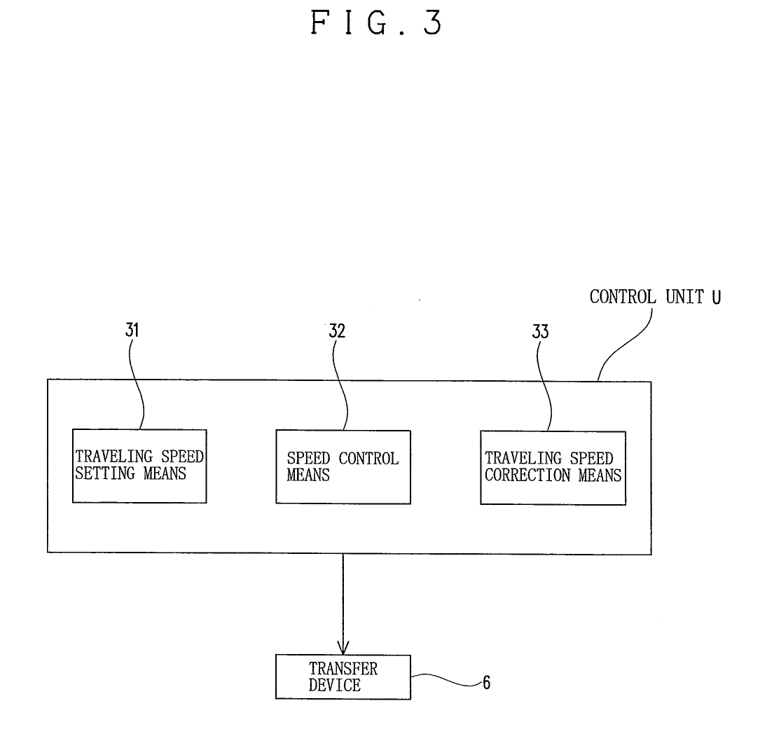

As shown in FIG. 3, the transfer device 6 is designed to be capable of controlling the traveling speed of the transfer film 5 by a control unit U.

The control unit U includes a traveling speed setting means 31 for setting the traveling speed of the transfer film 5 according to the thickness of the printed sheets (i.e., the thickness of each of printed sheets to be processed in one operation), a speed control means 32 for performing the speed control of the transfer section so as to match or adjust the speed of the transfer section to the traveling speed set by the traveling speed setting means 31, and the traveling speed correction means 33 for correcting the set traveling speed of the transfer film 5 in 1% unit.

The traveling speed setting means 31 is a means for setting the traveling speed of the transfer film 5 at a speed corresponding to the conveying speed of printed sheets having a certain thickness. As described later, by inputting the thickness of printed sheets into the control unit U, the control unit U calculates the traveling speed of the transfer film 5 corresponding to the conveying speed which varies according to the inputted thickness of printed sheets, and on the basis of the calculated traveling speed of the transfer film 5, controls drive of two electric motors M1, M2 (and additionally two electric motors 28, 30 according to the needs and circumstances) to output control signals to the two electric motors M1, M2 to enable them to match in speed to the conveying speed according to the thickness of printed sheets (i.e., the speed control means 32).

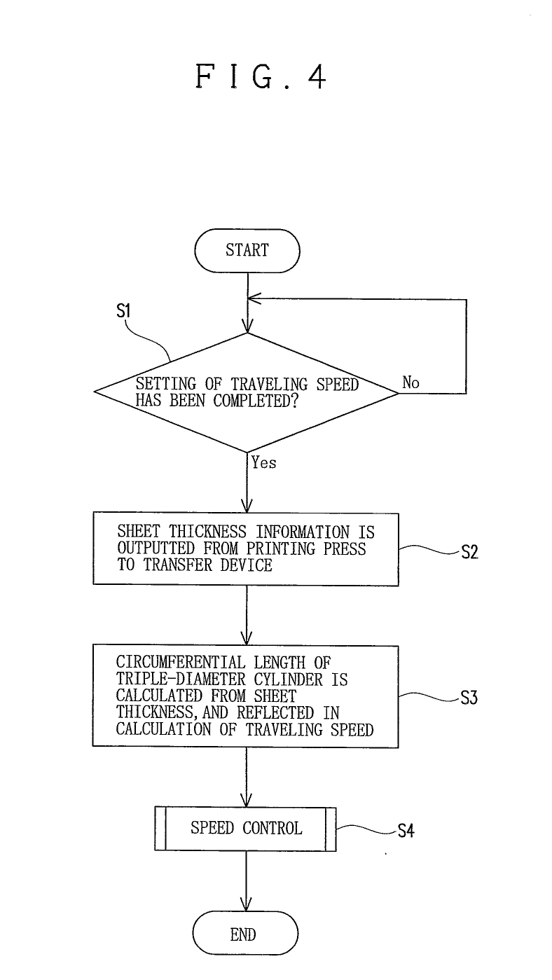

Now, the description will be made for the manner of speed control of the electric motors M1, M2 by the speed control means 32 with reference to the flowchart of FIG. 4.

First, the control unit U checks whether the setting of the traveling speed of the transfer film 5 has been completed or not (Step S1), and if the setting of the traveling speed of the transfer film 5 has been completed, the sheet thickness information is outputted to the transfer device 6 (Step S2). Then, the circumferential length of a triple-diameter cylinder 19 is calculated on the basis of the outputted sheet thickness, and the calculated result is reflected in the calculation of the traveling speed of the transfer film 5 (Step S3). Upon the calculation of the traveling speed of the transfer film 5, the control enters into a speed control subroutine and continues speed control until the printing press is stopped (Step S4).

Now, the description will be made for the calculation of the traveling speed of the transfer film 5. With the thickness of printed sheets 2 being T mm, the distance, through which the printed sheets 2 travel per one mechanical rotation on the triple-diameter cylinder 19, is represented by the expression: (225+2T)×π mm. The numerical value “225” is a diameter in millimeter of a single-diameter cylinder, and one rotation of the single-diameter cylinder is herein designated as one mechanical rotation.

On the other hand, when a sheet thickness, which is as close as possible to zero, is set at 0 mm for convenience' sake, the distance through which a printed sheet 2 travels per one mechanical rotation on the triple-diameter cylinder 19 is 225π.

Accordingly, the traveling speed of the transfer film 5 with the thickness of the printed sheet 2 being T mm is set (225+2T)/225 times as much as the traveling speed of the transfer film 5 with the thickness of the printed sheets 2 being 0 mm.

At this time, when the traveling speed of the film with the sheet thickness being 0 mm is S mm/hour (that is, the same speed as the mechanical rotation speed), the traveling speed of the film with the sheet thickness being T mm is S×(225+2T)/225 mm/hour. Thus, the control unit U calculates the traveling speed of a film having a certain thickness by using this operational expression.

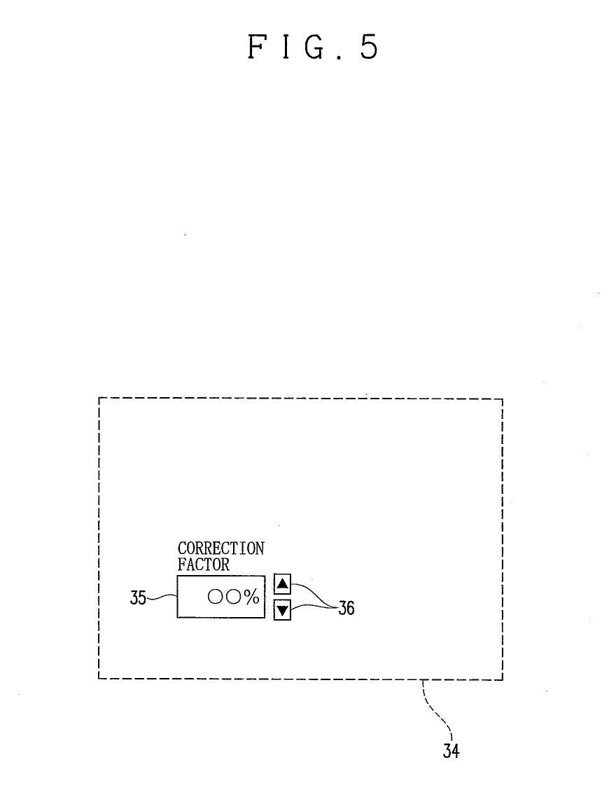

When slippage occurs even if the drive of the two electric motors M1, M2 is controlled to make the traveling speed of a film match or correspond to the conveying speed of printed sheets which varies according to the thickness of a printed sheet in the manner described above, the traveling speed can be corrected in the manner shown in FIG. 5. Specifically, the traveling speed of the transfer film 5 can be corrected in 1% unit by pressing an up-down operation part 36 disposed alongside a display column 35 of the correction factor displayed on a touch panel for performing various operations of the printing press. By setting this correction factor, the traveling speed of the transfer film 5 is corrected, thereby enabling prevention of slippage between the transfer film 5 and the printed sheets 2. In FIG. 5, only the display column 35 of the correction factor and the up-down operation part 36 are shown with the remaining portions omitted.

It is not necessary to limit the present invention to the above embodiment and can be subjected to various modifications within the intended scope of the present invention.

For example, in the above embodiment, the traveling speed of the transfer film 5 is calculated by the control unit U. Alternatively, it is possible to employ an arrangement, in which a table is previously prepared to contain plural or a large number of thicknesses of printed sheets as well as film traveling speeds respectively corresponding to the conveying speeds of printed sheets respectively corresponding to the plural or large number of thicknesses of printed sheets, and stored in a control unit. With this arrangement, an operator selects the traveling speed of the transfer film 5 corresponding to the thickness of sheets to be printed, which thickness is selected from among a plural or large number of pieces of data stored in the table, thereby setting the traveling speed of the transfer film 5.

The control unit U may be designed in the manner mentioned as follows. Specifically, the control unit U first detects whether the traveling speed of the transfer film 5 is matched to the conveying speed of oncoming printed sheets 2 conveyed by the triple-diameter cylinder 19; calculates the speed difference when they are not matched to each other; and automatically adjust the traveling speed of the transfer film 5 based on the calculated speed difference. A detection means for detecting the actual traveling speed of the transfer film 5 and a detection means for detecting the actual conveying speed of oncoming printed sheets 2 are provided so that the traveling speed of a transfer film is adjusted by inputting the detected values sent from both the detection means into the control unit U.

This specification is by no means intended to restrict the present invention to the preferred embodiments set forth therein. Various modifications to the transfer device and the transfer method for printed sheets, as described herein, may be made by those skilled in the art without departing from the spirit and scope of the present invention as defined in the appended claims.

What is claimed is:

1. A transfer device for printed sheets of paper comprising a transfer section for transferring patters of a transfer film onto a surface of each of printed sheets of paper conveyed by a cylinder; a traveling speed setting means for setting the traveling speed of a transfer film according to the thickness of each of the printed sheets of paper; and a speed control means for controlling the actual traveling speed of the transfer film so as to match the actual traveling speed of the transfer film to the traveling speed of the transfer film set by the traveling speed setting means.

2. The transfer device for printed sheets of paper according to claim 1, wherein the traveling speed setting means is a means for setting the traveling speed of the transfer film at a traveling speed corresponding to a certain thickness for printed sheets of paper, and the transfer device further comprising a traveling speed correction means for correcting the traveling speed of the transfer film set by the traveling speed setting means in 1% unit.

3. A transfer method for printed sheets of paper comprising transferring patters of a transfer sheet onto printed sheets of paper during conveyance of both the transfer sheet and the printed sheets of paper, wherein the traveling speed of the transfer film is matched to the conveying speed of the printed sheets of paper by adjusting the traveling speed of the transfer film according to the thickness of each of the printed sheets of paper.

4. The transfer method for printed sheets of paper according to claim 3, further comprising setting the traveling speed of the transfer film at a traveling speed corresponding to a certain thickness for printed sheets of paper, and correcting the set traveling speed of the transfer film in 1% unit.
